(19) United States
(12) Patent Application Publication
(10) Pub. No.: US 2014/0280263 A1
(43) Pub. Date: Sep. 18, 2014

(54) ELECTRONIC DEVICE WITH A FUNICTION OF APPLYING APPLICATIONS OF DIFFERENT OPERATING SYSTEMS AND METHOD THEREOF

(71) Applicant: POWER-ALL NETWORKS LIMITED, Shatin (HK)

(72) Inventor: STEVE LAP WAI HUI, Shatin (HK)

(73) Assignee: POWER-ALL NETWORKS LIMITED, Shatin (HK)

(21) Appl. No.: 14/207,416

(22) Filed: Mar. 12, 2014

(30) Foreign Application Priority Data
Mar. 15, 2013 (CN) 2013100833627

(51) Int. Cl. G06F 3/0481; G06F 3/0482; G06F 17/30

(52) U.S. Cl. CPC G06F 3/04817; G06F 17/30424; G06F 17/30076; G06F 3/0482
USPC 707/756; 707/769; 715/835

(57) ABSTRACT

A method for applying a plurality of applications of different operating systems on an electronic device, the method includes providing an icon interface and displaying the icon interface on the display unit. Storing installation information into a shared storage area of the storage unit after an application is installed on the electronic device in one operating system. The installation information comprises an installation identifier for identifying the installation information and an icon file corresponding to the installed application. Searching whether the shared storage area of the storage unit includes the installation information in response to an operation of returning to the icon interface. In addition, adding a corresponding icon to the icon interface according to the icon file of the installation information if yes.

### CROSS REFERENCE TO RELATED APPLICATIONS

This application is related to the following co-pending, commonly assigned patent applications, the disclosures of which are incorporated herein by reference in their entirety:

1. “SYSTEM FOR APPLYING APPLICATIONS OF DIFFERENT OPERATING SYSTEMS IN ONE ELECTRONIC DEVICE AND METHOD THEREOF” by Steve Lap Wai Hui, whose Attorney Docket No is US51414.

2. “ELECTRONIC DEVICE WITH A FUNCTION OF APPLYING APPLICATIONS OF DIFFERENT OPERATING SYSTEMS, SYSTEM AND METHOD” by Steve Lap Wai Hui, whose Attorney Docket No is US51415.

3. “ELECTRONIC DEVICE WITH A FUNCTION OF APPLYING APPLICATIONS OF DIFFERENT OPERATING SYSTEMS, SYSTEM AND METHOD THEREOF” by Steve Lap Wai Hui, whose Attorney Docket No is US51417.

4. “SYSTEM FOR UPDATING ICON INTERFACE WITH ICONS OF DIFFERENT OPERATING SYSTEMS AND METHOD THEREOF” by Steve Lap Wai Hui, whose Attorney Docket No is US51418.

### BACKGROUND

1. Technical Field

The present disclosure relates to electronic devices, and particularly to an electronic device with a function of applying a number of applications of different operating systems, and a system and a method thereof.

2. Description of Related Art

Electronic devices, such as mobile phones and tablet computers are popular. Two or more different operating systems may be installed in some electronic devices, such as, a WINDOWS operating system, a LINUX operating system, and an ANDROID operating system, and the electronic device can enter a certain operating system selected by a user or by default. However, when the electronic device enters one certain operating system, only the applications of the related entered operating system are displayed and can be applied. If the user wants to apply an application of another operating system and the user is not sure which operating system the application belongs to, the user should switch the electronic device from the current operating system to another operating system and search each operating system for the application, which is inconveniently.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an embodiment of an electronic device with a function of sharing a number of applications of different operating systems.

FIG. 2 is a schematic diagram of an embodiment of an icon interface.

FIG. 3 is a schematic diagram of another embodiment of an icon interface.

FIG. 4 is a flowchart diagram of an embodiment of a method for applying a number of applications of different operating systems on one electronic device.

FIG. 5 is a flowchart diagram of an embodiment of a step of updating icons of an icon interface, of the method of FIG. 4.

FIG. 6 is a flowchart diagram of an embodiment of a controlling step in response to an operation of an icon, of the method of FIG. 4.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

FIG. 1 shows an embodiment of an electronic device 100 with a function of applying a number of applications from different operating systems. A number of operating systems is installed in the electronic device 100, such as, a LINUX operating system, a WINDOWS operating system, an ANDROID operating system, and a MAC operating system. The electronic device 100 can be a mobile phone, a tablet computer, a portable computer, or a desktop computer, for example.

FIG. 1 shows that the electronic device 100 includes a display unit 10, a processing unit 20, and a storage unit 30. In the embodiment, the display unit 10 is a touch screen; in another embodiment, the display unit 201 can be a display screen and the display unit 10 may combine a keyboard or a touchpad to constitute an input/output device. The processing unit 20 can be a central processing unit, a digital processor, or a single chip, for example. The storage unit 30 can be a hard disk, a flash memory, or a compact disk, for example.

The processing unit 20 is used to run a system 51 for applying a number of applications of different operating systems on the electronic device 100. The system 51 includes an installation and uninstallation module 21, a storage controlling module 22, and an icon updating module 23. In the embodiment, the installation and uninstallation module 21, the storage controlling module 22, and the icon updating module 23 are collection of software instructions, and executed by the processing unit 20 of the electronic device 100.

FIG. 2 shows the display unit 10 displaying an icon interface TS, the icon interface TS includes a number of icons TI, each icon TI corresponds to an application running in an operating system. For example, the icons TI include a browser icon TI1 applied in the LINUX operating system, a media player 1 icon TI2 applied in the ANDROID system. In the embodiment, the electronic device 100 enters a corresponding operating system when being started up according to a selection of a user or by default. The icon interface TS is displayed on the display unit 10 of the electronic device 100 in the corresponding operating systems. FIG. 2 shows in the embodiment, the icons TI corresponding to different operating systems are arranged in the icon interface TS randomly. In another embodiment, the icon interface TS is independent from the operating systems installed in the electronic device 100, such as, the icon interface TS is run in an interface system different from the operating systems installed in the electronic device 100. For example, the interface system can be a small operating system developed personally and different from the known operating systems, such as the WINDOWS operating system and the ANDROID operating system.

FIG. 3 shows that in another embodiment, each operating system is assigned a corresponding area on the display unit 10 for locating the icons TI. For example, the icons TI belonging to the same operating system are located on the same at least one row. Therefore, a user can operate and manage the icons TI of the same operating system conveniently.

The installation and uninstallation module 21 is used to install an application into the electronic device 100 in response to an installation operation for the application. The installation and uninstallation module 21 also adds a corresponding icon TI to the icon interface TS after installing the application.

In the embodiment, as shown in FIG. 1, the storage unit 30 includes a shared storage area 31. The storage controlling module 22 is used to store installation information into the shared storage area 31 of the storage unit 30 after an application is installed on the electronic device 100 in one operating system. The shared storage area 31 of the storage unit 30 can be read and can be written when the electronic device 100 is operating in any operating system. The installation information includes an installation identifier and an icon file corresponding to the installed application. The icon file includes an icon name, an icon image, identification information of the installed application, and an operating system running the installed application. The installation identifier is used to identify the installation information.

The icon updating module 23 is used to search whether the shared storage area 31 of the storage unit 30 includes the installation information after an operating system of the electronic device 100 is started, namely, after the electronic device 100 completely enters the operating system. When the icon updating module 23 searches the installation information from the shared storage area 31, the icon updating module 23 adds a corresponding icon TI to the icon interface TS of the started operating system according to the icon file of the installation information. In detail, the icon updating module 23 adds a corresponding icon TI to the icon interface TS of the started operating system according to the icon file of the installation information as follows. The icon updating module 23 converts a format of the icon file of the installation information into a format supported by the started operating system, and then adds the icon TI to the icon interface TS of the started operating system according to the converted icon file.

The operating system is started completely indicating that the electronic device 100 is started up and then enters the operating system, or the electronic device 100 is switched from another operating system to the operating system. In the embodiment, as shown in FIG. 2, the icon interface TS also includes a number of operating system icons, such as an ANDROID operating system icon, and a WINDOWS operating system icon. The electronic device 100 can enter the corresponding operating system when the user operates the corresponding operating system icon. For example, if the user operates/selects the ANDROID operating system icon, then the electronic device 100 would be triggered to enter the ANDROID operating system. In another embodiment, the electronic device 100 switches from one operating system to another operating system in response to an operation on a particular key or item of the electronic device 100.

In another embodiment, the installation information also includes a system identifier for identifying the operating system in which the corresponding icon TI is already displayed on the icon interface TS of the operating system. The icon updating module 23 also determines whether the icon interface TS of the started operating system already has the icon TI corresponding to the icon file according to the converted icon file. If yes, then the icon updating module 23 does not add the icon TI corresponding to the icon file to the icon interface TS of the started operating system. In detail, if the icon updating module 23 determines the started operating system is the same as the operating system identified by the system identifier. It is determined that the icon interface TS of the started operating system already has the icon TI corresponding to the icon file of the installation information, and does not add the icon TI corresponding to the icon file to the icon interface TS of the started operating system.

In the embodiment, the installation and uninstallation module 21 also uninstalls an application of the electronic device 100 in response to an uninstallation operation for the application. The installation and uninstallation module 21 also deletes a corresponding icon TI from the icon interface TS after uninstalling the application.

The storage controlling module 22 also stores uninstallation information into the shared storage area 31 of the storage unit 30 after the application of the electronic device 100 in one operating system is uninstalled. The uninstallation information includes an uninstalled identifier and an icon file corresponding to the uninstalled application. Correspondingly, the uninstalled identifier is used to identify the uninstallation information. The icon file includes an icon name, an icon image, identification information of the uninstalled application, and an operating system running the uninstalled application.

The icon updating module 23 also searches whether the shared storage area 31 of the storage unit 30 includes the uninstallation information after an operating system of the electronic device 100 is started completely, namely, after the electronic device 100 enters the operating system completely. When the icon updating module 23 searches the uninstallation information from the shared storage area 31, the icon updating module 23 deletes a corresponding icon TI from the icon interface TS of the started operating system according to the icon file of the uninstallation information. In detail, the icon updating module 23 converts the format of the icon file to the format supported by the started operating system, and determines the icon TI displayed on the icon interface TS according to the converted icon file, and then deletes the determined icon TI from the icon interface TS.

Therefore, when the electronic device 100 has installed an application in one operating system, the icon TI corresponding to the application is added to the icon interface TS of another operating system after switching to the another operating system. When the electronic device 100 has uninstalled an application in one operating system, the icon TI corresponding to the application is removed/deleted from the icon interface TS of another operating system after switching to another operating system.

In the embodiment, the system S1 also includes an operation detection module 24, an application determination module 25, and an execution controlling module 26 which are collection of software instructions.

The operation detection module 24 detects operations on the icon interface TI by the user and determines an icon TI selected by the user according to the operation of the user.

The application determination module 25 is used to determine an application corresponding to the selected icon TI and an operating system supporting the application.

The execution controlling module 26 determines whether the operating system currently running in the electronic device 100 is the same as the operating system determined by the application determination module 25. If yes, the execution controlling module 26 controls to execute the application directly. If not, the operating system switches the operating system of the electronic device 100 to the determined operating system, and then controls to execute the application in the switched operating system. For example, if the operating system currently running in the electronic device 100 is the LINUX operating system, and the application determination module 25 determines the application corresponding to the selected icon TI is a media player 1 (ANDROID) and the operating system supporting the application is the ANDROID operating system, then the execution controlling module 26 switches the operating system of the electronic device 100 to the ANDROID operating system, and then executes the application in the ANDROID operating system.

In the embodiment, the storage unit 30 stores relationship information of each icon TI, the relationship information includes identification information of the application corresponding to the icon TI and identification information of the corresponding operating system. The application determination module 25 obtains the identification information according to the icon TI selected by the user, and determines the application corresponding to the selected icon TI according to the identification information of the application. In addition, determines the operating system supporting the application according to the identification information of the operating system. In the embodiment, the execution controlling module 26 that starts the operating system can be switched from another operating system to the operating system of the electronic device 100.

FIG. 4 shows a flowchart of a method for applying a number of applications of different operating systems on one electronic device. The method is applied in the electronic device 100 of FIG. 1.

The method includes steps of: 1) executing a step of updating the icons TI of the icon interface TS (S31); and 2) executing a controlling step in response to operating an icon TI of the icon interface TS (S32).

FIG. 5 is a detail flowchart diagram of the step (S31) of updating icons of an icon interface of the method of FIG. 4.

At first, the installation and uninstall module 21 installs an application into the electronic device 100 in response to an installation operation for the application. Then the storage controlling module 2 stores installation information of the application into the shared storage area 31 of the storage unit 30 after the application is installed on the electronic device 100 (S401). The installation information includes an installation identifier and an icon file corresponding to the installed application. The icon file includes an icon name, an icon image, identification information of the installed application, and an operating system running the installed application. The installation identifier is used to identify the installation information.

The icon updating module 23 searches whether the shared storage area 31 of the storage unit 30 includes the installation information after an operating system of the electronic device 100 is started up (S403).

If yes, the icon updating module 23 adds a corresponding icon TI to the icon interface TS of the operating system according to the icon file of the installation information (S405). In detail, the icon updating module 23 converts a format of the icon file of the installation information into a format supported by the started operating system, and then adds the icon TI to the icon interface TS of the operating system according to the converted icon file.

In the embodiment, the step S31 also includes steps: the storage controlling module 22 stores uninstallation information into the shared storage area 31 of the storage unit 30 after an application of the electronic device 100 in one operating system is uninstalled (S407).

The icon updating module 23 searches whether the shared storage area 31 of the storage unit 30 includes the uninstallation information after an operating system is started up (S409). The uninstallation information includes an uninstalled identifier and an icon file corresponding to the uninstalled application. The uninstalled identifier is used to identify the uninstallation information.

If yes, the icon updating module 23 deletes a corresponding icon TI from the icon interface TS of the started operating system according to the icon file of the uninstallation information (S411). In detail, the icon updating module 23 converts the format of the icon file to the format supported by the started operating system, and determines the icon TI corresponding to the icon file from the icon interface TS according to the converted icon file, and then deletes the determined icon TI from the icon interface TS.

FIG. 6 is a flowchart diagram of an embodiment of a controlling step (S32) in response to an operation of an icon, of the method of FIG. 4.

The operation detection module 24 detects operations on the icon interface TI by the user and determines an icon TI selected by the user according to the operation of the user (S501).

The application determination module 25 determines an application corresponding to the selected icon TI and an operating system supporting the application (S503).

The execution controlling module 26 determines whether the operating system currently running in the electronic device 100 is the same as the operating system determined by the application determination module 25 (S505).

If yes, the execution controlling module 26 controls to execute the application directly (S507).

If not, the execution controlling module 26 switches the operating system of the electronic device to the determined operating system and controls to execute the application in the switched operating system (S509).

Therefore, based on the electronic device 100, the system S1 and the method, the present disclosure enables the user to apply the applications of different operating systems conveniently.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device with a function of applying a plurality of applications of different operating systems, the electronic device installed a plurality of operating systems, the electronic device comprising:
a display unit configured to display an icon interface;
a storage unit comprising a shared storage area; and
a processing unit comprising:
an installation and uninstallation module configured to install an application into an operating system which the electronic device is running on in response to an installation operation for the application;
a storage controlling module configured to store installation information of the application into the shared storage area of the storage unit after the application is installed on the electronic device, wherein the installation information comprising an installation identifier for identifying the installation information and an icon file corresponding to the installed application;
an icon updating module configured to search whether the shared storage area of the storage unit comprises one installation information after an operating system of the electronic devices is started up completely, and add a corresponding icon to an icon interface of the started operating system according to the icon file of the installation information when searching the installation information of the storage unit.

2. The electronic device according to claim 1, wherein the icon updating module converts a format of the icon file of the installation information into a format supported by the started operating system, and then adds the icon to the icon interface of the started operating system according to the converted icon file.

3. The electronic device according to claim 1, wherein the installation information further comprises a system identifier for identifying an operating system in which the corresponding icon is already displayed on the icon interface of the operating system; the icon updating module is further configured to determine whether the icon interface of the started operating system already has the icon corresponding to the icon file according to the converted icon file, and does not add the icon corresponding to the icon file to the icon interface of the operating system if the icon interface of the started operating system already has the icon corresponding to the icon file of the installation information.

4. The electronic device according to claim 1, wherein the installation and uninstallation module is further configured to uninstall an application of the electronic device in response to an uninstallation operation for the application and delete a corresponding icon from the icon interface after uninstalling the application; the storage controlling module is further configured to store uninstallation information into the shared storage area of the storage unit after the application of the electronic device in one operating system is uninstalled, the uninstallation information comprises an uninstalled identifier for identifying the uninstallation information and an icon file corresponding to the uninstalled application.

5. The electronic device according to claim 4, wherein the icon updating module is further configured to search whether the shared storage area of the storage unit comprises the uninstallation information after an operating system is started up completely, and delete a corresponding icon from the icon interface of the operating system according to the icon file of the uninstallation information when searching the uninstallation information of the storage unit.

6. The electronic device according to claim 5, wherein the icon updating module converts the format of the icon file to the format supported by the operating system, and determines the icon corresponding to the icon file from the icon interface of the operating system, and then deletes the determined icon from the icon interface.

7. An electronic device with a function of applying a plurality of applications of different operating systems, the electronic device installed a plurality of operating systems, the electronic device comprising:
a display unit configured to display an icon interface;
a processing unit comprising:
an operation detection module configured to detect operations on the icon interface by the user and determines an icon selected by the user according to the operation of the user;
an application determination module configured to determine an application corresponding to the selected icon and an operating system supporting the application; and
an execution controlling module configured to determine whether the operating system currently running in the electronic device is the same as the operating system determined by the application determination module, and control to execute the application directly if yes; and to switch the operating system of the electronic device to the determined operating system and control to execute the application in the switched operating system if not.

8. The electronic device according to claim 7, further comprising a storage unit storing relationship information of each icon of the icon interface, the relationship information comprises identification information of the application corresponding to the icon and identification information of the corresponding operating system; the application determination module obtains the identification information according to the icon selected by the user, and determines the application corresponding to the selected icon according to the identification information of the application, and determines the operating system supporting the application according to the identification information of the operating system.

9. A method for applying a plurality of applications of different operating systems on an electronic device, the electronic device comprises a display unit and a storage unit, the method comprising:
storing installation information into a shared storage area of the storage unit after an application is installed on the electronic device in one operating system, wherein the installation information comprises an installation identifier for identifying the installation information and an icon file corresponding to the installed application;
searching whether the shared storage area of the storage unit comprises the installation information after an operating system is started up completely; and
adding a corresponding icon to the icon interface of the started operating system according to the icon file of the installation information when searching the installation information of the storage unit.

10. The method according to claim 9, further comprising:
storing uninstallation information into the shared storage area of the storage unit after an application of the electronic device in one operating system is uninstalled, wherein the uninstallation information comprises an uninstalled identifier for identifying the uninstallation information and an icon file corresponding to the uninstalled application;
searching whether the shared storage area of the storage unit comprises the uninstallation information after an operating system is started up completely; and
deleting a corresponding icon from the icon interface of the started operating system according to the icon file of the uninstallation information when searching the uninstallation information of the storage unit.

11. The method according to claim 9, wherein the step of adding a corresponding icon of the started operating system to the icon interface according to the icon file of the installation information comprises:
converting a format of the icon file of the installation information into a format supported by the started operating system; and
adding the icon to the icon interface according to the converted icon file.

12. The method according to claim 10, wherein the step of deleting a corresponding icon from the icon interface of the started operating system according to the icon file of the uninstallation information comprises:
converting the format of the icon file to the format supported by the started operating system, and determining the icon corresponding to the icon file from the icon interface, and then deleting the determined icon from the icon interface.

13. A method for applying a plurality of applications of different operating systems on an electronic device, the electronic device comprises a display unit, the method comprising:
detecting operations on the icon interface by the user and determining an icon selected by the user according to the operation of the user;
determining an application corresponding to the selected icon and an operating system supporting the application; and
determining whether the operating system currently running in the electronic device is the same as the determined operating system;
controlling to execute the application directly if yes; and
switching the operating system of the electronic device to the determined operating system and controlling to execute the application in the switched operating system if not.

14. The method according to claim 13, wherein the step of determining an application corresponding to the selected icon and an operating system supporting the application comprises:
obtaining identification information according to the icon selected by the user, wherein the relationship information comprises identification information of the application corresponding to the icon and identification information of the corresponding operating system; and
determining the application corresponding to the selected icon according to the identification information of the application, and determining the operating system supporting the application according to the identification information of the operating system.
